(19) United States
(12) Patent Application Publication
(10) Pub. No.: US 2019/0154114 A1
(43) Pub. Date: May 23, 2019

(54) POWER TRANSFER BELT FOR CONTINUOUSLY VARIABLE TRANSMISSION

(71) Applicant: AISIN AW CO., LTD., Anjo-shi, Aichi-ken (JP)

(72) Inventors: Akira OCHI, Anjo (JP); Yuki SATO, Nishio (JP); Ryo NAKAMURA, Anjo (JP); Kenji KAWANO, Nukata (JP); Masashi HATTORI, Anjo (JP); Junichi TOKUNAGA, Anjo (JP)

(73) Assignee: AISIN AW CO., LTD., Anjo-shi, Aichi-ken (JP)

(21) Appl. No.: 16/066,099

(22) PCT Filed: Nov. 11, 2016
(86) PCT No.: PCT/JP2016/083542

§ 371 Date: Jun. 26, 2018

(30) Foreign Application Priority Data
Feb. 12, 2016 (JP) 2016-024784

(51) Int. Cl. F16G 5/16

(52) U.S. Cl. CPC F16G 5/16

(57) ABSTRACT

A power transfer belt, where a peripheral length difference between an inner peripheral length of the retainer ring and an outer peripheral length of the outermost ring material is larger than a peripheral length difference between an outer peripheral length of the ring material on an inner side, of two of the ring materials which overlap each other, and an inner peripheral length of the ring material on an outer side,

### TECHNICAL FIELD

The present disclosure relates to a power transfer belt for a continuously variable transmission.

### BACKGROUND ART

There has hitherto been known a power transfer belt that includes an endless band (stacked ring) made of metal, a plurality of elements made of metal, and a slip-off prevention body (retainer ring) that is made of metal and slightly wider than the band (see Patent Document 1, for example). Each of the elements of the power transfer belt has a pair of pillar portions that extend upward from the upper end portions, on both sides, of a body portion that forms a horizontal portion. A recessed portion that accommodates the band and the slip-off prevention body is formed between the pair of pillar portions. The distal ends of the pillar portions are engagement protrusions bent inward. An open portion that is slightly wider than the band and slightly narrower than the slip-off prevention body is formed between the pair of engagement protrusions. The slip-off prevention body is fitted in the recessed portion via the opening portion after the band is accommodated in the recessed portions of the plurality of elements. Consequently, the plurality of elements can be prevented from slipping off from the band by the slip-off prevention body.

### RELATED ART DOCUMENTS

### Patent Documents

[Patent Document 1] Japanese Patent Application Publication No. 2001-193796 (JP 2001-193796 A)

### SUMMARY OF THE INVENTION

As discussed above, the slip-off prevention body must be able to pass through the open portion which is narrower than the slip-off prevention body. In view of the assemblability of the slip-off prevention body to the plurality of elements, the rigidity of the slip-off prevention body is preferably low. If the rigidity of the slip-off prevention body is low, however, the durability of the slip-off prevention body may also be low. In addition, a large tension acting on the slip-off prevention body is not preferable in terms of the durability.

It is therefore a main object of the present disclosure to improve the durability of a retainer ring of a power transfer belt including a stacked ring, a plurality of elements, and the retainer ring while securing the assemblability of the retainer ring to the plurality of elements.

The present disclosure provides a power transfer belt wound around a primary pulley and a secondary pulley of a continuously variable transmission, including: a stacked ring that includes a plurality of ring materials stacked in a thickness direction; a plurality of elements arranged annularly along the stacked ring and each having a saddle surface that contacts an inner peripheral surface of the stacked ring, a pair of pillar portions that extend in a radial direction of the stacked ring from both sides of the saddle surface in a width direction, and a pair of hook portions that face each other and that project in the width direction of the saddle surface from respective free end portions of the pillar portions; and a retainer ring disposed on a radially outer side of an outermost ring material of the stacked ring and on a radially inner side of the hook portions of the plurality of elements, and having a width that is larger than a spacing between the pair of hook portions in the width direction, in which a peripheral length difference between an inner peripheral length of the retainer ring and an outer peripheral length of the outermost ring material is larger than a peripheral length difference between an outer peripheral length of the ring material on an inner side, of two of the ring materials which overlap each other, and an inner peripheral length of the ring material on an outer side.

With such a power transfer belt, when the stacked ring is expanded with a tension acting on the stacked ring during operation of the continuously variable transmission, it is possible to prevent the tension from substantially acting on the retainer ring by securing a clearance between the stacked ring and the retainer ring. Thus, the retainer ring can be prevented from being expanded without increasing the rigidity of the retainer ring more than necessary. As a result, it is possible to improve the durability of the retainer ring while securing the assemblability of the retainer ring to the plurality of elements.

The present disclosure also provides a power transfer belt wound around a primary pulley and a secondary pulley of a continuously variable transmission, including: a stacked ring that includes a plurality of ring materials stacked in a thickness direction; a plurality of elements arranged annularly along the stacked ring and each having a saddle surface that contacts an inner peripheral surface of the stacked ring, a pair of pillar portions that extend in a radial direction of the stacked ring from both sides of the saddle surface in a width direction, and a pair of hook portions that face each other and that project in the width direction of the saddle surface from respective free end portions of the pillar portions; and a retainer ring disposed on a radially outer side of an outermost ring material of the stacked ring and on a radially inner side of the hook portions of the plurality of elements, and having a width that is larger than a spacing between the pair of hook portions in the width direction, in which an inner peripheral length of the retainer ring is determined so as to be longer than an outer peripheral length of the outermost ring material at a time when a tension acts on the stacked ring during operation of the continuously variable transmission.

With such a power transfer belt, a clearance is formed between the stacked ring and the retainer ring when the stacked ring is expanded with a tension acting on the stacked ring during operation of the continuously variable transmission. Consequently, during operation of the continuously variable transmission, it is possible to secure a clearance between the stacked ring and the retainer ring at least partially in the circumferential direction of the stacked ring so that the tension does not substantially acts on the retainer ring. Thus, the retainer ring can be prevented from being expanded without increasing the rigidity of the retainer ring more than necessary. As a result, it is possible to improve the durability of the retainer ring while securing the assemblability of the retainer ring to the plurality of elements.

### BRIEF DESCRIPTION OF THE DRAWINGS

FIG. 1 is a schematic diagram illustrating an example of a continuously variable transmission that includes a power transfer belt according to the present disclosure.

FIG. 2 is a partial sectional view illustrating the power transfer belt according to the present disclosure.

FIG. 3 is a front view illustrating an element included in the power transfer belt according to the present disclosure.

FIG. 4 is a plan view illustrating a retainer ring included in the power transfer belt according to the present disclosure.

FIG. 5 illustrates the clearance between a stacked ring and the retainer ring and the clearance between the retainer ring and a hook portion.

### MODES FOR CARRYING OUT THE INVENTION

Now, an embodiment of the invention according to the present disclosure will be described with reference to the drawings.

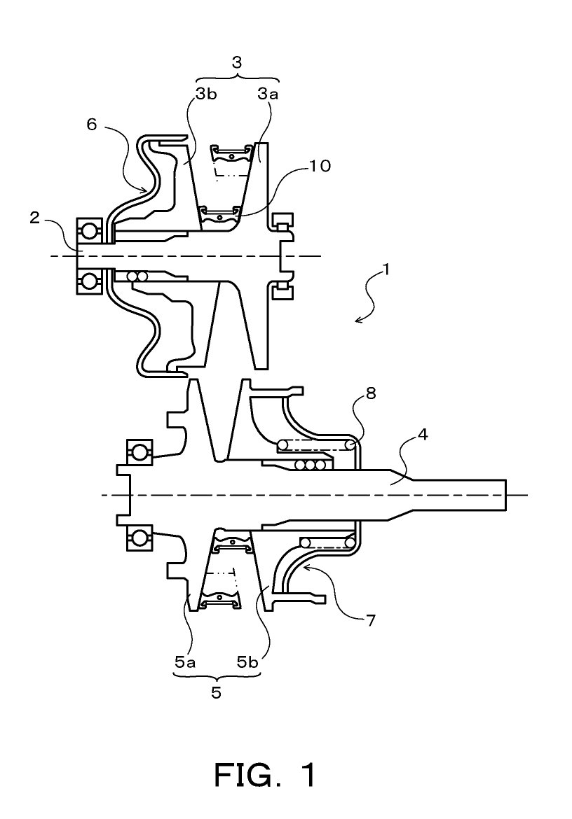

FIG. 1 illustrates a schematic configuration of a continuously variable transmission 1 that includes a power transfer belt 10 according to the present disclosure. The continuously variable transmission 1 illustrated in the drawing includes a primary shaft 2 that serves as a drive side rotary shaft, a primary pulley 3 provided on the primary shaft 2, a secondary shaft 4 that serves as a driven side rotary shaft disposed in parallel with the primary shaft 2, and a secondary pulley 5 provided on the secondary shaft 4. As illustrated in the drawing, the power transfer belt 10 is wound around a pulley groove (V groove) of the primary pulley 3 and a pulley groove (V groove) of the secondary pulley 5.

The primary shaft 2 is coupled to an input shaft (not illustrated) coupled to a power generation source such as an engine (internal combustion engine) via a forward/reverse switching mechanism (not illustrated). The primary pulley 3 includes a fixed sheave 3a formed integrally with the primary shaft 2, and a movable sheave 3b supported so as to be slidable in the axial direction via a ball spline or the like on the primary shaft 2. Meanwhile, the secondary pulley 5 includes a fixed sheave 5a formed integrally with the secondary shaft 4, and a movable sheave 5b supported so as to be slidable in the axial direction via a ball spline or the like on the secondary shaft 4 and urged in the axial direction by a return spring 8.

The continuously variable transmission 1 further includes a primary cylinder 6 which is a hydraulic actuator that changes the groove width of the primary pulley 3, and a secondary cylinder 7 which is a hydraulic actuator that changes the groove width of the secondary pulley 5. The primary cylinder 6 is formed behind the movable sheave 3b of the primary pulley 3. The secondary cylinder 7 is formed behind the movable sheave 5b of the secondary pulley 5. Working oil is supplied from a hydraulic control device (not illustrated) to the primary cylinder 6 and the secondary cylinder 7 in order to vary the groove widths of the primary pulley 3 and the secondary pulley 5. This makes it possible to continuously vary torque transferred from the engine or the like to the primary shaft 2 via the input shaft and the forward/reverse switching mechanism and to output the resultant torque to the secondary shaft 4. The torque which is output to the secondary shaft 4 is transferred to drive wheels (neither of which is illustrated) of the vehicle via a gear mechanism, a differential gear, and drive shafts.

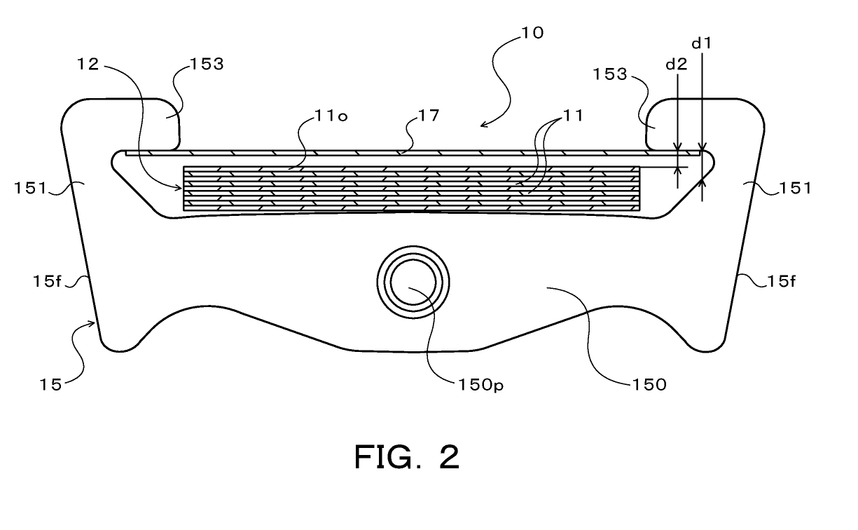

FIG. 2 is a partial sectional view illustrating the power transfer belt 10. As illustrated in the drawing, the power transfer belt 10 includes one stacked ring 12 constituted by stacking a plurality of (nine in the present embodiment) elastically deformable ring materials 11 in the thickness direction (ring radial direction), a plurality of (e.g. several hundreds of) elements 15 arranged (bound) annularly along the inner peripheral surface of the stacked ring 12, and a retainer ring 17. The plurality of elastically deformable ring materials 11 which constitute the stacked ring 12 are cut out from a drum made of a steel sheet, and processed so as to have generally equal thicknesses (e.g. about 180 to 190 μm) and different circumferential lengths determined in advance.

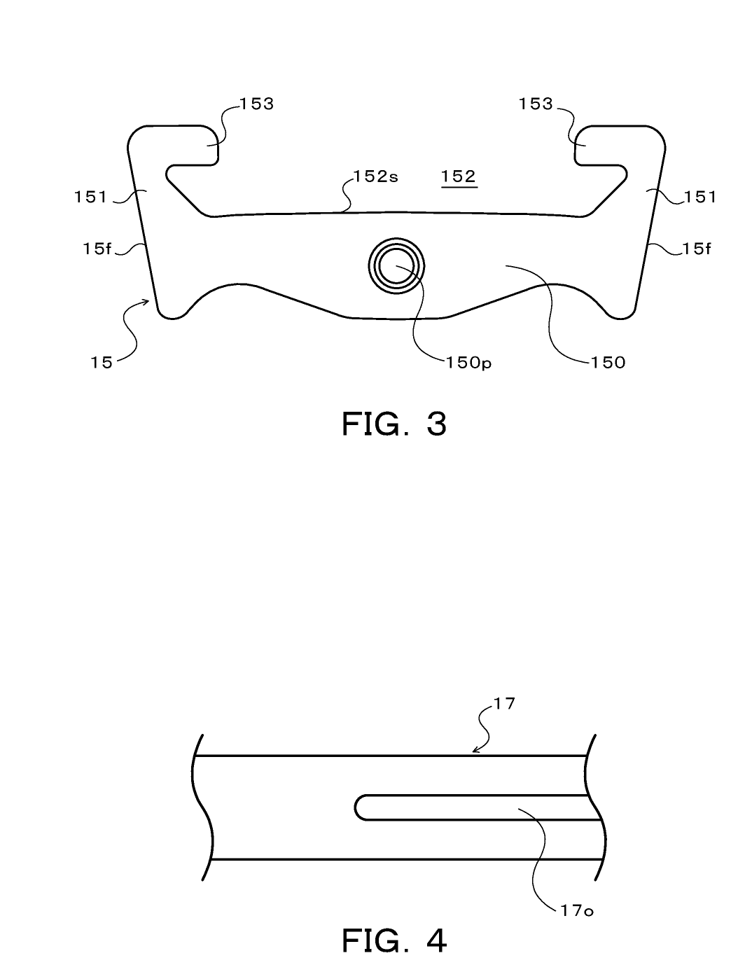

Each of the elements 15 has been stamped out from a steel sheet by pressing, for example. As illustrated in FIG. 3, each of the elements 15 has a base portion 150 that extends horizontally in the drawing, a pair of pillar portions 151 that extend in the same direction from both end portions of the base portion 150, and a recessed portion 152 defined between the pair of pillar portions 151 so as to open on free end-side of the pillar portions 151. Side surfaces of the element 15 (side surfaces of the base portion 150) on both sides are flank surfaces 15f that serve as torque transfer surfaces that abut against the surfaces of the pulley groove of the primary pulley 3 and the pulley groove of the secondary pulley 5. Further, one protrusion (dimple) 150p is formed at the center portion, in the width direction, of one of the surfaces of the base portion 150. A recessed portion (not illustrated) to be freely fitted with the protrusion 150p of the adjacent element 15 is formed on the back side of the protrusion 150p.

The pair of pillar portions 151 extend outward (upward in the drawing) in the radial direction of the stacked ring 12 from both sides, in the width direction, of a saddle surface 152s which is the bottom surface of the recessed portion 152. Hook portions 153 that project in the width direction of the saddle surface 152s are formed at free end portions of the pillar portions 151. The pair of hook portions 153 face each other in the width direction with a spacing that is slightly larger than the width of the stacked ring 12 (ring materials 11). As illustrated in FIG. 2, the stacked ring 12 is disposed in the recessed portion 152, and the saddle surface 152s of the recessed portion 152 contacts the inner peripheral surface of the stacked ring 12, that is, the innermost ring material 11. The saddle surface 152s has a so-called crowning shape in which the saddle surface 152s is gently inclined downward in the drawing from the center portion in the width direction as the top portion toward the outer side in the width direction.

The retainer ring 17, which is elastically deformable, is cut out from a drum made of a steel sheet, for example, and has a thickness that is generally equal to or smaller than that of the ring material 11 and a width that is larger than the spacing, in the width direction, between the pair of hook portions 153. The retainer ring 17 is elastically deformed to be fitted in the recessed portion 152 via the gap between the hook portions 153 of each of the elements 15. The retainer ring 17 is disposed between the outer peripheral surface of an outermost ring material 11o (see FIG. 2) of the stacked ring 12 and the hook portions 153 of each of the elements 15 to surround the stacked ring 12, and restricts slipping-off of each of the elements 15 from the stacked ring 12. Consequently, the plurality of elements 15 are bound (arranged) annularly along the inner peripheral surface of the stacked ring 12. In the present embodiment, as illustrated in

FIG. 4, a single long opening 17o is formed in the retainer ring 17. Consequently, the assemblability of the retainer ring 17 to the elements 15 can be secured by making the retainer ring 17 easily elastically deformable. A plurality of openings 17o may be formed in the retainer ring 17 at intervals in the circumferential direction.

In addition, the retainer ring 17 has an inner peripheral length that is longer than the outer peripheral length of the outermost ring material 11o of the stacked ring 12. Consequently, as illustrated in FIG. 2, an annular clearance is formed between the outer peripheral surface of the outermost ring material 11o and the inner peripheral surface of the retainer ring 17 when the stacked ring 12 and the retainer ring 17 are disposed concentrically (a no-load state in which no tension acts). In the present embodiment, the inner peripheral length of the retainer ring 17 is determined such that the clearance between the outer peripheral surface of the outermost ring material 11o and the inner peripheral surface of the retainer ring 17 is slightly larger than the thickness of the ring material 11, for example, in the no-load state described above. In the present embodiment, further, as illustrated in FIG. 2, the outer peripheral length of the retainer ring 17 is determined such that the outer peripheral surface of the retainer ring 17 abuts against the inner peripheral surfaces of the hook portions 153 of each of the elements 15 when the stacked ring 12 and the retainer ring 17 are disposed concentrically.

With the elements 15 of the power transfer belt 10 discussed above, it is possible to improve the torque transfer efficiency by causing a rocking edge (not illustrated) that serves as a torque transfer portion to approach the saddle surface 152s. With the elements 15, in addition, the cost can be reduced by reducing the materials as compared to elements that support two (two lines of) stacked rings. With the power transfer belt 10 which includes the elements 15, on the other hand, it is necessary to improve the durability while securing the assemblability of the retainer ring 17 which is not present in a power transfer belt that includes two stacked rings. Therefore, the present inventors made diligent studies and analyses from the viewpoint of improving the durability of the retainer ring 17. As a result, it was found that the durability of the retainer ring 17 was significantly lowered and the retainer ring 17 was possibly damaged or broken during operation of the continuously variable transmission 1 in the case where the power transfer belt 10 was configured such that the retainer ring 17 contacted the stacked ring 12 (see FIGS. 3, 4, etc. of Patent Document 1 described above).

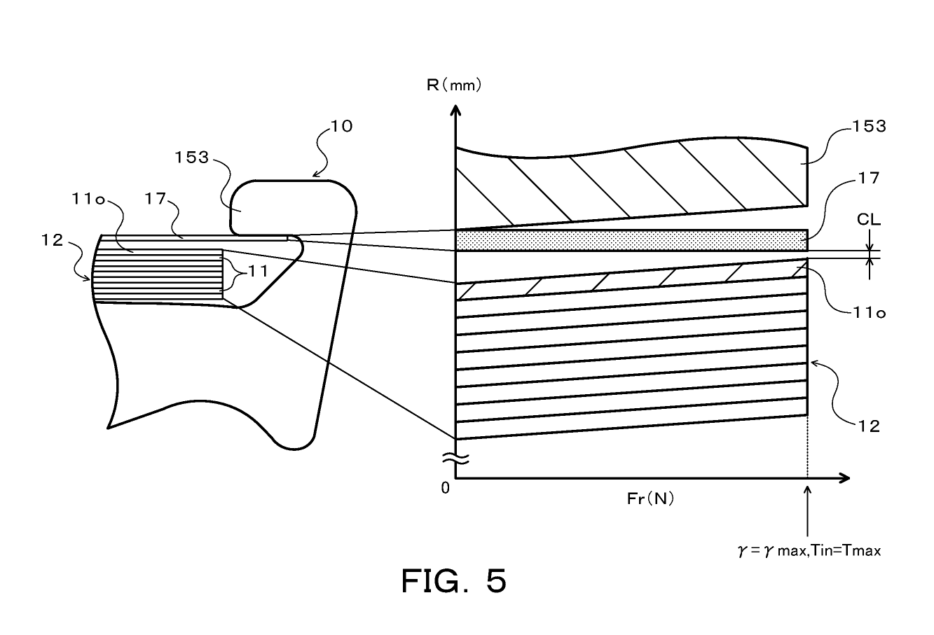

That is, with the continuously variable transmission 1, as illustrated in FIG. 5, as torque transferred to the primary pulley 3 becomes larger, a tension Fr that acts on the stacked ring 12 becomes larger, and accordingly the amount of expansion of the stacked ring 12 becomes larger (symbol “R” in FIG. 5 indicates the distance from the center of the power transfer belt 10 to the inner peripheral surface or the outer peripheral surface of the ring materials 11 and the retainer ring 15). In addition, during operation of the continuously variable transmission 1, as illustrated in FIG. 5, the tension Fr which acts on the stacked ring 12 and the amount of expansion of the stacked ring 12 each become maximum when torque Tin transferred from the engine or the like to the primary pulley 3 with the continuously variable transmission 1 in a maximum speed ratio state (a state in which a speed ratio γ is set to a lowest speed ratio γmax) becomes maximum (Tin=Tmax). When the amount of expansion of the stacked ring 12 becomes larger, the tension Fr which acts on the retainer ring 17 becomes higher along with an increase in diameter of the stacked ring 12, that is, the outermost ring material 11o. When the tension Fr exceeds an allowable tensile stress, the retainer ring 17 may be broken. When the clearance between the outer peripheral surface of the stacked ring 12 and the inner peripheral surfaces of the hook portions 153 is too large, in addition, the behavior of the elements 15 with respect to the stacked ring 12 may be degraded (become unstable).

In the power transfer belt 10 according to the present embodiment, in the light of the above, the inner peripheral length of the retainer ring 17 (when not expanded) is determined so as to be longer than the outer peripheral length of the outermost ring material 11o at the time when the tension Fr acts on the stacked ring 12 during operation of the continuously variable transmission 1. Specifically, the inner peripheral length of the retainer ring 17 is determined so as to be longer than the outer peripheral length of the outermost ring material 11o at the time when torque (input torque Tin) transferred from the engine or the like to the primary pulley 3 with the continuously variable transmission 1 in the maximum speed ratio state is maximum (Tin=Tmax). That is, in designing the power transfer belt 10, the outer peripheral length of the outermost ring material 11o at the time when the input torque Tin is maximum in the maximum speed ratio state is calculated on the basis of the maximum speed ratio γmax of the continuously variable transmission 1, the maximum input torque Tmax, the specifications of the primary pulley 3, the secondary pulley 5, and the stacked ring 12, etc., and the inner peripheral length of the retainer ring 17 is made longer than the calculated outer peripheral length of the outermost ring material 11o. Consequently, the peripheral length difference between the retainer ring 17 and the outermost ring material 11o is larger than the peripheral length difference between the ring materials 11 which overlap each other, that is, the maximum value of the peripheral length difference between the ring materials 11 which overlap each other. The peripheral length difference between the inner peripheral length of the retainer ring 17 and the outer peripheral length of the outermost ring material 111o is larger than the maximum value of the peripheral length difference between the outer peripheral length of the ring material 11 on the inner side, of two ring materials 11 which overlap each other, and the inner peripheral length of the ring material 11 on the outer side. That is, the peripheral length difference between the inner peripheral length of the retainer ring 17 and the outer peripheral length of the outermost ring material 111o is larger than the peripheral length difference between the outer peripheral length of the ring material 11 in the n-th layer (inner side) and the inner peripheral length of the ring material 11 in the (n+1)-th layer (outer side) (“n” is an integer of 1 to N (=the total number of the stacked ring −1).

In the thus configured power transfer belt 10, as illustrated in FIG. 5, a clearance CL is formed between the stacked ring 12 and the retainer ring 17 at least partially in the circumferential direction even when the amount of expansion of the stacked ring 12 (and the tension Fr) is maximum by the effect of the tension Fr with torque transferred to the primary pulley 3 maximized with the continuously variable transmission 1 in the maximum speed ratio state. Consequently, during operation of the continuously variable transmission 1, it is possible to secure a clearance between the stacked ring and the retainer ring at least partially (around the element 15 which is held by the primary pulley 3, etc.) in the circumferential direction of the stacked ring so that the tension Fr does not substantially acts on the retainer ring 17. Thus, the retainer ring 17 can be prevented from being expanded without increasing the rigidity of the retainer ring 17 more than necessary. As a result, it is possible to improve the durability of the retainer ring 17 while securing the assemblability of the retainer ring 17 to the plurality of elements 15.

In addition, as seen from FIG. 5, the clearance between the outer peripheral surface of the retainer ring 17 and the inner peripheral surfaces of the hook portions 153 is minimized when no torque is transferred to the primary pulley 3, and becomes larger as the element 15 which is held (interposed) by the primary pulley 3 and the stacked ring 12 are moved radially outward along with an increase in torque transferred to the primary pulley 3. In the power transfer belt 10 according to the present embodiment, in the light of the above, the outer peripheral length of the retainer ring 17 is determined such that the outer peripheral surface of the retainer ring 17 abuts against the inner peripheral surfaces of the hook portions 153 of each of the elements 15 with the stacked ring 12 and the retainer ring 17 disposed concentrically (in the no-load state in which no tension Fr acts). That is, when no torque is transferred to the primary pulley 3, the outer peripheral surface of the retainer ring 17 abuts against the inner peripheral surfaces of the hook portions 153 of the plurality of elements 15, and the clearance between the outer peripheral surface of the retainer ring 17 and the inner peripheral surfaces of the hook portions 153 becomes substantially zero.

Consequently, it is possible to further reduce the clearance between the outer peripheral surface of the retainer ring 17 and the inner peripheral surfaces of the hook portions 153 when each of the elements 15 is moved radially outward along with an increase in torque transferred to the primary pulley 3. As a result, an increase in clearance between the outer peripheral surface of the stacked ring 12 and the inner peripheral surfaces of the hook portions 153 of each of the elements 15 can be suppressed, which makes it possible to suppress degradation in behavior of the element 15 (the element 15 becoming unstable).

In the power transfer belt 10 according to the present embodiment, further, a distance d1 between the inner peripheral surfaces of the hook portions 153 (portions that abut against the retainer ring 17) and portions of the element 15 that face the inner peripheral surfaces of the hook portions 153 (the inner surfaces of the pillar portions 151 in the present embodiment) is longer than a shortest distance d2, in the radial direction (height direction of the element 15) between the inner peripheral surfaces of the hook portions 153 and the outer peripheral surface of the outermost ring material 11o (see FIG. 2). Consequently, the retainer ring 17 can be prevented from contacting each of the elements 15 during operation of the continuously variable transmission 1, which makes it possible to suppress application of a stress from the element 15 to the retainer ring 17 when a holding force acts on the element 15 from the fixed sheave 3a and the movable sheave 3b of the primary pulley 3 or the fixed sheave 5a and the movable sheave 5b of the secondary pulley 5. As a result, it is possible to further improve the durability of the retainer ring 17.

As has been described above, the present disclosure provides a power transfer belt (10) wound around a primary pulley (3) and a secondary pulley (5) of a continuously variable transmission (1), including: a stacked ring (12) that includes a plurality of ring materials (11, 11o) stacked in a thickness direction; a plurality of elements (15) arranged annularly along the stacked ring (12) and each having a saddle surface (152s) that contacts an inner peripheral surface of the stacked ring (12), a pair of pillar portions (151) that extend in a radial direction of the stacked ring (12) from both sides of the saddle surface (152s) in a width direction, and a pair of hook portions (153) that face each other and that project in the width direction of the saddle surface (152s) from respective free end portions of the pillar portions (151); and a retainer ring (17) disposed on a radially outer side of an outermost ring material (11o) of the stacked ring (12) and on a radially inner side of the hook portions (153) of the plurality of elements (15), and having a width that is larger than a spacing between the pair of hook portions (153) in the width direction. In the power transfer belt (10), a peripheral length difference between an inner peripheral length of the retainer ring (17) and an outer peripheral length of the outermost ring material (11o) is larger than a peripheral length difference between an outer peripheral length of the ring material (11) on an inner side, of two of the ring materials (11) which overlap each other, and an inner peripheral length of the ring material (11) on an outer side.

With such a power transfer belt, when the stacked ring is expanded with a tension acting on the stacked ring during operation of the continuously variable transmission, it is possible to prevent the tension from substantially acting on the retainer ring by securing a clearance between the stacked ring and the retainer ring. Thus, the retainer ring can be prevented from being expanded without increasing the rigidity of the retainer ring more than necessary. As a result, it is possible to improve the durability of the retainer ring while securing the assemblability of the retainer ring to the plurality of elements.

The present disclosure also provides a power transfer belt (10) wound around a primary pulley (3) and a secondary pulley (5) of a continuously variable transmission (1), including: a stacked ring (12) that includes a plurality of ring materials (11, 11o) stacked in a thickness direction; a plurality of elements (15) arranged annularly along the stacked ring (12) and each having a saddle surface (152s) that contacts an inner peripheral surface of the stacked ring (12), a pair of pillar portions (151) that extend in a radial direction of the stacked ring (12) from both sides of the saddle surface (152s) in a width direction, and a pair of hook portions (153) that face each other and that project in the width direction of the saddle surface (152s) from respective free end portions of the pillar portions (151); and a retainer ring (17) disposed on a radially outer side of an outermost ring material (11o) of the stacked ring (12) and on a radially inner side of the hook portions (153) of the plurality of elements (15), and having a width that is larger than a spacing between the pair of hook portions (153) in the width direction. In the power transfer belt (10), an inner peripheral length of the retainer ring (17) is determined so as to be longer than an outer peripheral length of the outermost ring material (11o) at a time when a tension acts on the stacked ring (12) during operation of the continuously variable transmission (1).

With such a power transfer belt, a clearance is formed between the stacked ring and the retainer ring when the stacked ring is expanded with a tension acting on the stacked ring during operation of the continuously variable transmission. Consequently, during operation of the continuously variable transmission, it is possible to secure a clearance between the stacked ring and the retainer ring at least partially in the circumferential direction of the stacked ring so that the tension does not substantially acts on the retainer ring. Thus, the retainer ring can be prevented from being expanded without increasing the rigidity of the retainer ring more than necessary. As a result, it is possible to improve the durability of the retainer ring while securing the assemblability of the retainer ring to the plurality of elements.

The inner peripheral length of the retainer ring (17) may be determined so as to be longer than the outer peripheral length of the outermost ring material (11o) at a time when torque transferred to the primary pulley (3) is maximum with the continuously variable transmission (1) in a maximum speed ratio state.

An outer peripheral length of the retainer ring (17) may be determined such that an outer peripheral surface of the retainer ring (17) abuts against inner peripheral surfaces of the hook portions (153) of the plurality of elements (15). Consequently, it is possible to further reduce the clearance between the outer peripheral surface of the retainer ring and the inner peripheral surfaces of the hook portions when each of the elements is moved radially outward along with an increase in torque transferred to the primary pulley. As a result, an increase in clearance between the outer peripheral surface of the stacked ring and the inner peripheral surfaces of the hook portions of each of the elements can be suppressed, which makes it possible to suppress degradation in behavior of the element (the element becoming unstable).

A distance between inner peripheral surfaces of the hook portions (153) and portions of the element (15) that face the inner peripheral surfaces of the hook portions (153) may be longer than a distance between the inner peripheral surfaces of the hook portions (153) and an outer peripheral surface of the outermost ring material (11o). Consequently, the retainer ring can be prevented from contacting the elements during operation of the continuously variable transmission, which makes it possible to suppress application of a stress from the elements to the retainer ring when a holding force acts on the elements from the primary pulley or the secondary pulley. As a result, it is possible to further improve the durability of the retainer ring 17.

The invention according to the present disclosure is not limited to the embodiment described above in any way, and it is a matter of course that the invention may be modified in various ways without departing from the range of the extension of the present disclosure. Further, the embodiment described above is merely a specific form of the invention described in the “SUMMARY OF THE INVENTION” section, and does not limit the elements of the invention described in the “SUMMARY OF THE INVENTION” section.

### INDUSTRIAL APPLICABILITY

The invention according to the present disclosure is applicable to the power transfer belt and continuously variable transmission manufacturing industry, etc.

1. A power transfer belt wound around a primary pulley and a secondary pulley of a continuously variable transmission, the power transfer belt comprising:
a stacked ring that includes a plurality of ring materials stacked in a thickness direction;
a plurality of elements arranged annularly along the stacked ring and each having a saddle surface that contacts an inner peripheral surface of the stacked ring, a pair of pillars that extend in a radial direction of the stacked ring from both sides of the saddle surface in a width direction, and a pair of hooks that face each other and that project in the width direction of the saddle surface from respective free ends of the pillars; and
a retainer ring disposed on a radially outer side of an outermost ring material of the stacked ring and on a radially inner side of the shooks of the plurality of elements, and having a width that is larger than a spacing between the pair of hooks in the width direction, wherein
a peripheral length difference between an inner peripheral length of the retainer ring and an outer peripheral length of the outermost ring material is larger than a peripheral length difference between an outer peripheral length of the ring material on an inner side, of two of the ring materials which overlap each other, and an inner peripheral length of the ring material on an outer side.

2. A power transfer belt wound around a primary pulley and a secondary pulley of a continuously variable transmission the power transfer belt comprising:
a stacked ring that includes a plurality of ring materials stacked in a thickness direction;
a plurality of elements arranged annularly along the stacked ring and each having a saddle surface that contacts an inner peripheral surface of the stacked ring, a pair of pillars that extend in a radial direction of the stacked ring from both sides of the saddle surface in a width direction, and a pair of hooks that face each other and that project in the width direction of the saddle surface from respective free ends of the pillars; and
a retainer ring disposed on a radially outer side of an outermost ring material of the stacked ring and on a radially inner side of the hooks of the plurality of elements, and having a width that is larger than a spacing between the pair of hooks in the width direction, wherein
an inner peripheral length of the retainer ring is determined so as to be longer than an outer peripheral length of the outermost ring material at a time when a tension acts on the stacked ring during operation of the continuously variable transmission.

3. The power transfer belt according to claim 2, wherein
the inner peripheral length of the retainer ring is determined so as to be longer than the outer peripheral length of the outermost ring material at a time when torque transferred to the primary pulley is maximum with the continuously variable transmission in a maximum speed ratio state.

4. The power transfer belt according to claim 3, wherein
an outer peripheral length of the retainer ring is determined such that an outer peripheral surface of the retainer ring abuts against inner peripheral surfaces of the hooks of the plurality of elements.

5. The power transfer belt according to claim 4, wherein
a distance between inner peripheral surfaces of the hooks and portions of the element that face the inner peripheral surfaces of the hooks is longer than a shortest distance, in a radial direction, between the inner peripheral surfaces of the hooks and an outer peripheral surface of the outermost ring material.

6. The power transfer belt according to claim 1, wherein
an outer peripheral length of the retainer ring is determined such that an outer peripheral surface of the retainer ring abuts against inner peripheral surfaces of the hooks of the plurality of elements.

7. The power transfer belt according to claim 6, wherein
a distance between inner peripheral surfaces of the hooks and portions of the element that face the inner peripheral surfaces of the hooks is longer than a shortest distance, in a radial direction, between the inner peripheral surfaces of the hooks and an outer peripheral surface of the outermost ring material.

8. The power transfer belt according to claim 1, wherein
a distance between inner peripheral surfaces of the hooks and portions of the element that face the inner peripheral surfaces of the hooks is longer than a shortest distance, in a radial direction, between the inner peripheral surfaces of the hooks and an outer peripheral surface of the outermost ring material.

9. The power transfer belt according to claim 2, wherein
an outer peripheral length of the retainer ring is determined such that an outer peripheral surface of the retainer ring abuts against inner peripheral surfaces of the hooks of the plurality of elements.

10. The power transfer belt according to claim 9, wherein
a distance between inner peripheral surfaces of the hooks and portions of the element that face the inner peripheral surfaces of the hooks is longer than a shortest distance, in a radial direction, between the inner peripheral surfaces of the hooks and an outer peripheral surface of the outermost ring material.

11. The power transfer belt according to claim 2, wherein
a distance between inner peripheral surfaces of the hooks and portions of the element that face the inner peripheral surfaces of the hooks is longer than a shortest distance, in a radial direction, between the inner peripheral surfaces of the hooks and an outer peripheral surface of the outermost ring material.
